(19) United States
(12) Patent Application Publication
(10) Pub. No.: US 2020/0158815 A1
(43) Pub. Date: May 21, 2020

(54) Method of Determining Locomotive Position by Triangulation

(71) Applicant: Westinghouse Air Brake Technologies Corporation, Wilmerding, PA (US)

(72) Inventors: Andrew Ryan Staats, Cedar Rapids, IA (US); Stuart John Barr, Cedar Rapids, IA (US)

(21) Appl. No.: 16/193,036

(22) Filed: Nov. 16, 2018

(51) Int. Cl. G01S 5/14; H04W 4/42; G01S 5/02

(52) U.S. Cl. CPC G01S 5/14; G01S 5/0221; H04W 4/42

(57) ABSTRACT

In a method of determining the location of a locomotive when GPS signals are not available, triangulation between one or two radio transmitters and, respectively, two or one radio receivers mounted on the train can be used. In the method, the distance between each radio transmitter and each radio receiver can be determined according a number of cycles of the radio signal generated by the radio transmitter that are received/counted by the radio receiver. The radio signal can also have modulated thereon the geographical location of the radio transmitter, which location can be demodulated by the radio receiver. Utilizing the demodulated geographical location of each radio transmitter and the distance between the radio transmitter and each radio receiver, triangulation can be used to determine the geographical location of the train.

### BACKGROUND OF THE INVENTION

### Field of the Invention

The present invention relates to determining the geographical position of a locomotive or train when GPS signals are unavailable and when dead-reckoning may not be reliable or to verify the integrity of the geographical position of the locomotive for the purpose of train control.

### Description of Related Art

In the case where a locomotive cannot use GPS to identify its current position (e.g. in a tunnel or a canyon), it relies on dead-reckoning and a growing position offset to identify its location. This position offset, however, can grow at a rate of approximately 4 meters for every assumed kilometer traveled and can, therefore, become increasingly unreliable for the purpose of train control.

It would, therefore, be desirable to provide a system and method that enables the geographical position of the locomotive or train to be accurately determined when GPS signals are not available.

### SUMMARY OF THE INVENTION

Generally, provided is a system and method for identifying the position of a moving vehicle, when GPS satellite signals are not available. The disclosed system and method finds particular application, and will be described hereinafter, in connection with identifying the position of a train, in particular, a rail vehicle of the train, such as a locomotive, when GPS satellite signals are not available. However, this is not to be construed in a limiting sense.

According to one preferred and non-limiting embodiment or example, disclosed herein is a method for determining the position of the rail vehicle based on triangulation distance determination.

In one preferred and non-limiting embodiment or example, one, or two, or more stationary radio transmitters are provided, e.g., in a tunnel or other location where GPS satellite signals are not available or are intermittently available, with the geographical location of each radio transmitter available to or programmed into the radio transmitter. In one preferred and non-limiting embodiment or example, the geographical location of each radio transmitter can be available to or programmed into the radio transmitter in any suitable and/or desirable manner including, without limitation, via GPS satellite signals when available or via surveying. The particular manner by which the geographical location of each radio transmitter is available to said radio transmitter is not to be construed in a limiting sense. Where there are two radio transmitters, they can be positioned a known distance apart. In an example, this fixed distance can be utilized along with one or more other distances determined in the manner described herein to determine the geographical location of the train.

In one preferred and non-limiting embodiment or example, one or two radio receivers can be mounted on the train, in an example, on or proximate a leading edge of a first vehicle of the train, which, in an example, can be a locomotive, where each radio receiver can have unobstructed access to the radio signal output by each radio transmitter. Where there are two radio receivers, they can be mounted a fixed distance apart on the vehicle. In an example, this fixed distance can be utilized along with one or more other distances determined in the manner described herein to determine the geographical location of the train.

In one preferred and non-limiting embodiment or example, each radio receiver can process a radio signal output by each radio transmitter and can determine from a number of cycles of the radio signal received by or counted by said radio receiver a distance from the radio receiver to said radio transmitter. In one preferred and non-limiting embodiment or example, this processing can occur sufficiently quickly, e.g., a few milliseconds or a few microseconds, such that the determined distance is still valid for the purpose of train control notwithstanding movement of the train between the initial receipt of the radio signal and the determination of the distance. For the purpose of train control during movement of the train, even at high speeds, e.g., in excess of 200-250 kilometers per hour, the time to process the radio signal to determine the distance can be considered real-time or substantially real-time e.g., a few milliseconds or a few microseconds.

In one preferred and non-limiting embodiment or example, each radio signal can have modulated thereon the geographical location of the radio transmitter transmitting the radio signal. In an example, each geographical location can include a longitude and latitude of the transmitting radio transmitter.

In one preferred and non-limiting embodiment or example, the geographical location of each radio transmitter can be demodulated from the radio signal received from said radio transmitter.

In one preferred and non-limiting embodiment or example, where a first radio transmitter and two radio receivers are provided, using some combination of two or more of (1) the fixed distance between the two radio receivers, (2) the distance from the first radio transmitter to a first one of the radio receivers (determined from the number of cycles of the radio signal generated or output by the first radio transmitter and received by or counted by said first radio receiver), and (3) the distance from the first radio transmitter to a second one of the radio receivers (determined from the number of cycles of the radio signal generated or output by the first radio transmitter and received by and/or counted by said second radio receiver), triangulation distance determination can be used to determine a first geographical location of the train.

Additionally, in this example, where a second radio transmitter is also provided in addition to the first radio transmitter and the two radio receivers, using some combination of two or more of (1) the fixed distance between the two radio receivers, (2) the distance from the second radio transmitter to the first radio receiver (determined from the number of cycles of the radio signal generated or output by the second radio transmitter and received by or counted by said first radio receiver), and (3) the distance from the second radio transmitter to the second radio receiver (determined from the number of cycles of the radio signal generated or output by the second radio transmitter and received by and/or counted by said second radio receiver), triangulation distance determination can be used to determine a second geographical location of the train.

In another preferred and non-limiting embodiment or example, where a first radio receiver and two radio transmitters are provided, using some combination of two or more of (1) the fixed distance between the two radio transmitters, (2) the distance from a first one of the radio transmitters to the first radio receiver (determined from the number of cycles of the radio signal generated or output by the first radio transmitter and received by and/or counted by said first radio receiver), and (3) the distance from the second one of the radio transmitters to the first radio receiver (determined from the number of cycles of the radio signal generated or output by the second radio transmitter and received by and/or counted by the first radio receiver), triangulation distance determination can be used to determine a first geographical location of the train.

Additionally, in this example, where a second radio receiver is also provided in addition to the first radio receiver and the two radio transmitters, using some combination of two or more of (1) the fixed distance between the two radio transmitters, (2) the distance from the second radio transmitter to the first radio receiver (determined from the number of cycles of the radio signal generated or output by the second radio transmitter and received by and/or counted by the first radio receiver), and (3) the distance from the second radio transmitter to the second radio receiver (determined from the number of cycles of the radio signal generated or output by the second radio transmitter and received by and/or counted by the second radio receiver), triangulation distance determination can be used to determine a second geographical location of the train.

In one preferred and non-limiting embodiment or example, the first and second geographical locations of the train can be the same. In an example, the first and second geographical locations of the train can be different. In this latter example, an average of the first and second geographical can be used as the geographical location of the train.

In one preferred and non-limiting embodiment or example, instead of the radio receivers being mounted on or proximate a leading edge of the train, the radios receivers can, in another example, be mounted on or proximate a trailing edge of the train, e.g., on the last vehicle of the train.

In one preferred and non-limiting embodiment or example, the accuracy of the distance determination from each radio transmitter to each radio receiver can be a function of a wavelength of the radio signal used and train speed. In an example, it is envisioned that said accuracy may be better than using GPS. In an example, because of this accuracy, reliance on dead-reckoning to determine train location can be reduced or avoided in areas where GPS satellite signals are not available or are intermittently available, e.g., in tunnels or in canyons.

In one preferred and non-limiting embodiment or example, each radio transmitter can be standalone on a stationary wayside device or mounted on a mobile unit for temporary installation.

Further preferred and non-limiting embodiments are set forth in the following numbered clauses.

Clause 1: A method of determining a geographical location of a train comprises: (a) generating, by first and second radio transmitters located at first and second geographical locations, first and second radio signals having modulated thereon the respective first and second geographical locations; (b) receiving, by a first radio receiver mounted on the train, the first and second radio signals; (c) determining, by a controller mounted on the train, according to a first and a second number of cycles of the respective first and second radio signals received/counted by the first radio receiver, a first distance from the first radio receiver to the first radio transmitter and a second distance from the first radio receiver to the second radio transmitter; (d) demodulating, by the controller, from the first and second radio signals the first and second geographical locations; and (e) determining, by the controller, from the first and second distances of step (c) and the first and second geographical locations of step (d) a first geographical location of the train.

Clause 2: The method of clause 1 can further include: (f) receiving, by a second radio receiver mounted on the train, the first and second radio signals; (g) determining, by the controller, according to a third and a fourth number of cycles of the respective first and second radio signals received/counted by the second radio receiver, a third distance from the second radio receiver to the first radio transmitter and a fourth distance from the second radio receiver to the second radio transmitter; (h) determining, by the controller, from the third and fourth distances of step (g) and the first and second geographical locations of step (d) a second geographical location of the train.

Clause 3: The method of clause 1 or 2, wherein the first and second geographical locations of the train can be the same.

Clause 4: The method of any one of clauses 1-3, wherein the geographical location of a train can be a combination (average) of the first and second geographical locations.

Clause 5. The method of any one of clauses 1-4, wherein the controller can determine the first geographical location of the train via triangulation.

Clause 6: The method of any one of clauses 1-5, wherein the controller can determine the first and second geographical locations of the train via triangulation.

Clause 7: The method of any one of clauses 1-6, wherein the first and second radio transmitters can be located in a tunnel.

Clause 8: The method of any one of clauses 1-7, wherein the first radio receiver can mounted on a lead vehicle or a trailing vehicle of the train.

Clause 9: The method of any one of clauses 1-8, wherein the first and second radio signals can be transmitted at the same or different times.

Clause 10: A method of determining a geographical location of a train comprises: (a) generating, by a first radio transmitter located at first geographical location, a first radio signal having modulated thereon the first geographical location of the first radio transmitter; (b) receiving, by first and second radio receivers mounted on the train, the first radio signal; (c) determining, by a controller mounted on the train, according to a first and a second number of cycles of the first radio signal received/counted by the respective first and second radio receivers, a first distance from the first radio receiver to the first radio transmitter and a second distance from the second radio receiver to the first radio transmitter; (d) demodulating, by the controller, from the first radio signal the first geographical location of the first radio transmitter; and (e) determining, by the controller, from the first and second distances of step (c) and the first geographical location of step (d) a first geographical location of the train.

Clause 11: The method of clause 10 can further include: (f) generating, by a second radio transmitter located at second geographical location, a second radio signal having modulated thereon the second geographical location of the second radio transmitter; (g) receiving, by the first and second radio receivers, the second radio signal; (h) determining, by the controller, according to a third and a fourth number of cycles of the second radio signal received/counted by the respective first and second radio receivers, a third distance from the first radio receiver to the second radio transmitter and a fourth distance from the second radio receiver to the second radio transmitter; (i) demodulating, by the controller, from the second radio signal the second geographical location of the second radio transmitter; and (j) determining, by the controller, from the third and fourth distances of step (h) and the second geographical location of step (i) a second geographical location of the train.

Clause 12: The method of clause 10 or 11, wherein the first and second geographical locations of the train can be the same.

Clause 13: The method of any one of clauses 1-12, wherein the geographical location of a train can be a combination (average) of the first and second geographical locations.

Clause 14: The method of any one of clauses 1-13, wherein the controller can determine the first geographical location of the train via triangulation.

Clause 15. The method of any one of clauses 1-14, wherein the controller can determine the first and second geographical locations of the train via triangulation.

Clause 16: The method of any one of clauses 1-15, wherein the first and second radio transmitters can be located in a tunnel or in a canyon.

Clause 17: The method of any one of clauses 1-16, wherein the first and second radio receivers can be mounted on a lead vehicle (e.g., locomotive) or a trailing vehicle of the train.

Clause 18: The method of any one of clauses 1-17, wherein the first and second radio signals can be transmitted at different times.

Clause 19: The method of any one of clauses 1-18, wherein the first geographical location of the train in step (e) can be further determined based on a geographical location of the train determined by the controller prior to step (e).

Clause 20: The method of any one of clauses 1-19, wherein the geographical location of the train determined by the controller prior to step (e) can determined from (1) satellite (e.g., GPS) data, (2) a gyroscope (e.g., a MEMS based gyroscope), or (3) a heading of the train relative to a magnetic field of the earth (e.g., determined via a compass or a magnetometer).

### BRIEF DESCRIPTION OF THE DRAWINGS

These and other features of the present invention will become more apparent from the following description in which reference is made to the appended drawings wherein:

FIG. 1 is a schematic drawing of a system for determining a geographical location of a train in accordance with the principles of the present invention;

FIGS. 2A-2B are a flow diagram of a method of determining a geographical location of a train in accordance with the principles of the present invention; and

FIGS. 3A-3B are a flow diagram of a method of determining a geographical location of a train in accordance with the principles of the present invention.

### DESCRIPTION OF THE INVENTION

Various non-limiting examples will now be described with reference to the accompanying figures where like reference numbers correspond to like or functionally equivalent elements.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplifying examples or aspects of the invention. Hence, the specific examples or aspects disclosed herein are not to be construed as limiting.

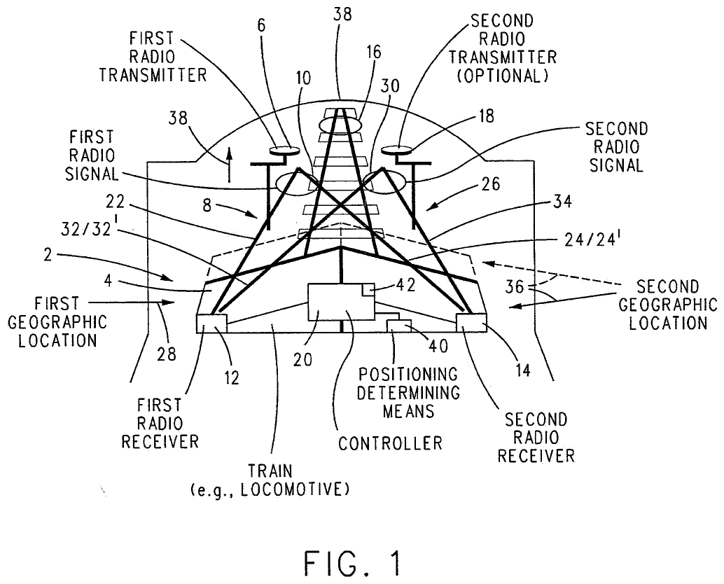

With reference to FIG. 1, in one preferred and non-limiting embodiment or example, in a method of determining a geographical location of a train 2, a first radio transmitter 6 can be positioned at a first geographical location 8. First radio transmitter 6 can be programmed or configured to output a first radio signal 10 having modulated thereon first geographical location 8 of first radio transmitter 6.

In one preferred and non-limiting embodiment or example, a first vehicle of train 2, e.g., a locomotive 4, can have first and second radio receivers 12 and 14 mounted thereon. In an example, first and second radio receivers 12 and 14 can be positioned laterally on opposite sides of locomotive 4 as shown in FIG. 1. In an example, first and second radio receivers 12 and 14 can be positioned on locomotive 4 such that each radio receiver 12 and 14 can have an unobstructed pathway for receiving first radio signal 10 from first radio transmitter 6 as train 2 travels on track 16 toward first radio transmitter 6 in the direction of arrow 38 in FIG. 1. For the purpose of description only, first and second radio receivers 12 and 14 will be described as being mounted on locomotive 4. However, this is not to be construed in a limiting sense.

In one preferred and non-limiting embodiment or example, a controller 20 can be provided on train 2 for processing the output of first radio receiver 12. In an example, controller 20 can include one or more processors and memory. Controller 20 can be part of or separate from first radio receiver 12. Controller 20 can be programmed or configured to process the output of first radio receiver 12 in the manner discussed hereinafter.

In one preferred and non-limiting embodiment or example, controller 20 can be programmed or configured to determine, according to a first and a second number of cycles of the first radio signal 10 received/counted by the respective first and second radio receivers 12 and 14, a first distance 22 from first radio receiver 12 to first radio transmitter 6 and a second distance 24 from second radio receiver 14 to first radio transmitter 6. In one preferred and non-limiting embodiment or example, controller 20 can be further programmed or configured to demodulate from first radio signal 10 the first geographical location 8 of first radio transmitter 6.

In one preferred and non-limiting embodiment or example, controller 20 can be programmed or configured to determine (in a manner described hereinafter) from the thus determined first and second distances 22 and 24 and the first geographical location 8 of first radio transmitter 6 demodulated from first radio signal 10 a first geographical location 28 of locomotive 4.

Hence, as can be seen, a single radio transmitter 6 and two radio receivers 12 and 14 can be utilized to determine a geographical location 28 of locomotive 4. In an example, an optional second radio transmitter 18 can be used with first radio transmitter 6 and first and second radio receivers 12 and 14 to determine the geographical location of locomotive 4.

In one preferred and non-limiting embodiment or example, as an aid to enabling the geographical location of locomotive 4 to be accurately determined, second radio transmitter 18 can be provided at a second geographical location 26. In an example, first and second geographical locations 8 and 26 can be proximate opposite sides of track 16. However, this is not to be construed in a limiting sense since it is envisioned that at least second radio transmitter 18 can be positioned at a second geographical location 26 deemed suitable and/or desirable relative to first geographical location 8 that enables second radio transmitter 18 to transmit a second radio signal 30 to first and second radio receivers 12 and 14. In other words, first geographical location 8 and second geographical location 26 can be anywhere conveniently relative to each other that enables first and second radio receivers 12 and 14 to have access to first and second radio signals 10 and 30.

In one preferred and non-limiting embodiment or example, on or about the same time that first radio transmitter 6 generates first radio signal 10, second radio transmitter 18 can generate second radio signal 30 having modulated thereon second geographical location 26 of second radio transmitter 18.

In an example, first and second radio receivers 12 and 14 can receive second radio signal 30 in addition to receiving first radio signal 10. In one preferred and non-limiting embodiment or example, controller 20 can determine, according to a third and fourth number of cycles of second radio signal 30 received/counted by the respective first and second radio receivers 12 and 14 a third distance 32 from first radio receiver 12 to second radio transmitter 18 and a fourth distance 34 from second radio receiver 14 to second radio transmitter 18.

In one preferred and non-limiting embodiment or example, controller 20 can then demodulate from second radio signal 30 the second geographical location 26 of second radio transmitter 18. In an example, controller 20 can then determine from the third and fourth distances 32 and 34 and the second geographical location 26 demodulated from second radio signal 30 a second geographical location 36 of locomotive 4.

In one preferred and non-limiting embodiment or example, second geographical location 36 can be the same as first geographical location 28. In another example, second geographical location 36 can be different than first geographical location 28, as shown in phantom lines in FIG. 1, based on, for example, the movement of locomotive 4 and sequence of controller 20 processing first and second radio signals 10 and 30. However, this is not to be construed in a limiting sense.

Where the first and second geographical locations 28 and 36 determined by controller 20 from first and second radio signals 10 and 30 are different, said first and second geographical locations 28 and 36 can be combined by controller 20 in any suitable and/or desirable manner to obtain an estimate of the actual geographical location of locomotive 4. For example, controller 20 can take an average of the first and second geographical locations 28 and 36 as an estimate of the actual geographical location of locomotive 4.

In one preferred and non-limiting embodiment or example, once controller 20 has determined from first radio signal 10 the first geographical location 8 of first radio transmitter 6 and first and second distances 22 and 24, controller 20 can utilize a triangulation distance measurement technique to determine the first geographical location 28 of locomotive 4. In another example, once controller 20 has determined from second radio signal 30 the second geographical location 26 of second radio transmitter 18 and third and fourth distances 32 and 34, controller 20 can utilize the triangulation distance measurement technique to determine the second geographical location 36 of locomotive 4. In an example, controller 20 can execute the triangulation distance measurement technique separately for each of the first radio signal 10 and the second radio signal 30.

In one preferred and non-limiting embodiment or example, first radio transmitter 6 and second radio transmitter 18 (when provided) can be located in a tunnel 38. However, this is not to be construed as limiting the invention since it is envisioned that each radio transmitter can be located at any suitable and/or desirable location where GPS signals are not available or are intermittently available.

In one preferred and non-limiting embodiment or example, each radio receiver can be mounted on the lead vehicle of the train, e.g., locomotive 4, or on a trailing vehicle of the train, or on any other location on the train that one skilled in the art would deem suitable and/or desirable. In an example, each radio receiver can be mounted an end of train (EOT) device (known in the art) that can be mounted on a trailing vehicle of the train.

In one preferred and non-limiting embodiment or example, the first and second radio signals 10 and 30 can be transmitted at different times to facilitate processing of first and second radio signals 10 and 30 by radio receiver 12 and/or 14.

In one preferred and non-limiting embodiment or example, to enable controller 20 resolve potential ambiguity in determining first geographical location 28, second geographical location 36, or both of locomotive 4, controller 20 can use a geographical location of locomotive 4 determined by controller 20 prior to first and/or second radio receivers 12 and 14 receiving first radio signal 10, second radio signal 30, or both. In an example, this potential ambiguity can arise from controller 20 not being able to unambiguously determine whether first and/or second geographical locations 28 and/or 36 are on the side of first radio transmitter 6 shown in FIG. 1, or on the other side of radio transmitter 6, e.g., in the distance (by reference number 16) shown in FIG. 1. In an example, this prior geographical location can be determined by controller 20 from an output of a position determining means 40. In an example, position determining means 40 can be a GPS receiver which can determine a prior geographical location of locomotive 4 from GPS satellite signals received at a time when said GPS satellite signals are available. In another example, location determining means 40 can be a gyroscope, such as a MEMS-based gyroscope. In another example, position determining means 40 can be a compass or a magnetometer. In another example, position determining means 40 can be a track database 42 that includes a virtual instance (or model) of track 16 upon which controller 20 can monitor the progress of locomotive 4 moving on the physical instance of track 16 shown in FIG. 1.

In one preferred and non-limiting embodiment or example, the foregoing description describes second ratio transmitter 18 as optional, whereupon only a single, first radio transmitter 6 and two radio receivers 12 and 14 can be utilized to determine a geographical location of locomotive 4. However, this is not to be construed in a limiting sense.

In one preferred and non-limiting embodiment or example, described next will be a method of determining a geographical location of locomotive 4 that utilizes two radio transmitters 6 and 18 and a single radio receiver 12 or 14.

In one preferred and non-limiting embodiment or example, in a method of determining a geographical location of locomotive 4, first and second radio transmitters 6 and 18 located at first and second geographical locations 8 and 26 can generate first and second radio signals 10 and 30 having modulated thereon the respective first and second geographical locations 8 and 26. In an example, first radio receiver 12 can receive the first and second radio signals 10 and 30. Controller 20 can determine, according to a first and a second number of cycles of the respective first and second radio signals 10 and 30 received/counted by first radio receiver 12, first distance 22 from first radio receiver 12 to first radio transmitter 6 and a second distance 44 from first radio receiver 12 to second radio transmitter 18.

In one preferred and non-limiting embodiment or example, controller 20 can demodulate from first and second radio signals 10 and 30, the first and second geographical locations 8 and 26 of first and second radio transmitters 6 and 18. In an example, controller 20 can then determine from first and second distances 22 and 44 and the first and second geographical locations 8 and 26 demodulated from first and second radio signals 10 and 30 a first geographical location 28 of locomotive 4.

In one preferred and non-limiting embodiment or example, as an aid to enabling the geographical location of locomotive 4 to be accurately determined, second radio receiver 14 can be provided to receive first and second radio signals 10 and 30. In an example, controller 20 can, according to a third and fourth number of cycles of the respective first and second radio signals 10 and 30 received/counted by second radio receiver 14, determine a third distance 46 from second radio receiver 14 to first radio transmitter 6 and a fourth distance 34 from second radio receiver 14 to second radio transmitter 18.

In one preferred and non-limiting embodiment or example, controller 20 can then determine from third and fourth distances 46 and 34 and the first and second geographical locations 8 and 26 demodulated from first and second radio signals 10 and 30, a second geographical location 36 of locomotive 4.

In an example, and as discussed above, the first and second geographical locations 28 and 36 of locomotive 4 can be the same or different. Where the first and second geographical locations 28 and 36 determined in the above manner are different, the geographical location of locomotive 4 can be a combination of said first and second geographical locations 28 and 36. In an example, this combination can be the average of the first and second geographical locations 28 and 36.

In one preferred and non-limiting embodiment or example, each geographical location of locomotive 4 can be determined via a triangulation distance measurement technique executed by controller 20. In an example, controller 20 can determine a fixed distance between first and second radio transmitters 6 and 18 from the first and second geographical locations 8 and 26 demodulated from first and second radio signals 10 and 30. Via this fixed distance and distances 22 and 44, controller 20 can determine the first geographical location 28 utilizing a triangulation distance measurement technique. Similarly, utilizing the fixed distance between first radio transmitter 6 and second radio transmitter 18 and distances 46 and 34, controller 20 can determine the second geographical location 36 utilizing the triangulation distance determining technique.

The triangulation distance determining technique (algorithm) is well known in the art and will not be described further herein in detail.

First and second radio transmitters 6 and 18 can be located in tunnel 38. However, as discussed above, this is not to be construed in a limiting sense since it is envisioned that first radio transmitter 6, second radio transmitter 18, or both, can be positioned at any suitable and/or desirable location where GPS signals are not available or are intermittently available.

Each radio receiver can be mounted to the lead vehicle of train 2, e.g., locomotive 4, or a trailing vehicle of train 2, or any other location on train 2 deemed suitable and/or desirable by one skilled in the art. In an example, the first and second radio signals 10 and 30 can be transmitted at the same time or at different times.

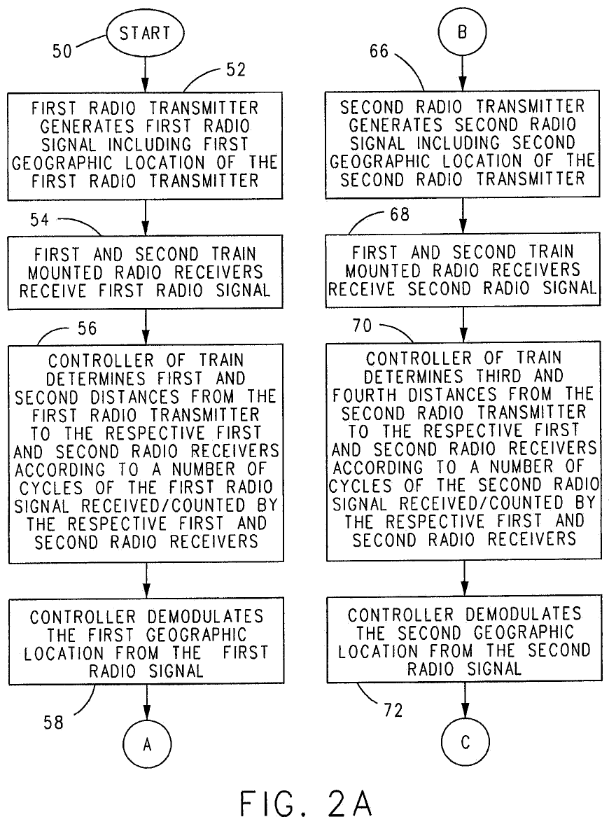

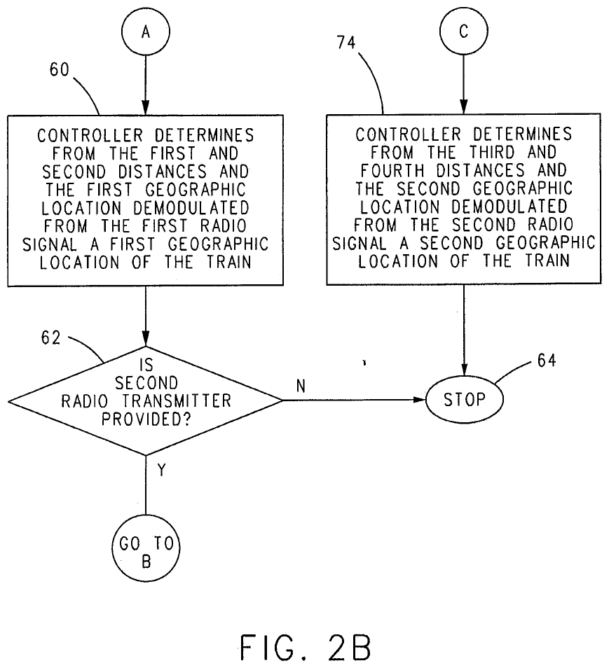

With reference to FIGS. 2A-2B and with continuing reference to FIG. 1, in one preferred and non-limiting embodiment or example, a method of determining a geographical location of locomotive 2 begins by advancing from a start step 50 to a step 52 wherein a first radio transmitter 6 located at a first geographical location 8 generates a first radio signal 10 having modulated thereon the first geographical location 8 of the first radio transmitter 6. In step 54, first and second radio receivers 12 and 14 mounted on locomotive 4 receive the first radio signal 10. In step 56, a controller 20 of train 2 determines first and second distances 22 and 24 from the first radio transmitter 6 to the respective first and second radio receivers 12 and 14 according to the number of cycles of the first radio signal 10 received/counted by the respective first and second radio receivers 12 and 14. In step 58, controller 20 demodulates the first geographical location 8 from the first radio signal 10 received by the first and/or second radio receivers. In step 60, controller 20 determines from the first and second distances 22 and 24 (determined in step 56) and the first geographical location 8 (determined in step 58) a first geographical location 28 of train 2.

If, in step 62, it is determined that second radio transmitter 18 is not provided, the method advances to a stop step 64. However, if second radio transmitter 18 is provided, the method advances to step 66 where second radio transmitter 18 generates a second radio signal 30 including the geographical location 26 of the second radio transmitter 18 modulated on the second radio signal 30. In step 68, the first and second radio receivers 12 and 14 receive the second radio signal 30. In step 70, controller 20 determines third and fourth distances 32 and 34 from the second radio transmitter 18 to the respective first and second radio receivers 12 and 14 according to a number of cycles of the second radio signal received/counted by the respective first and second radio receivers 12 and 14. In step 72, controller 20 demodulates the second geographical location 26 from the second radio signal 30. In step 74, controller 20 determines from the third and fourth distances 32 and 34 (determined in step 70) and the second geographical location 26 (determined in step 72) a second geographical location 36 of the train. The method then advances to stop step 64.

In one preferred and non-limiting embodiment or example, each geographical location can be determined via a triangulation distance measurement technique known in the art. The actual geographical location of train 2 can be the first geographical location 28, the second geographical location 36, or some combination (e.g., average) of the first and second geographical locations determined in steps 60 and 74.

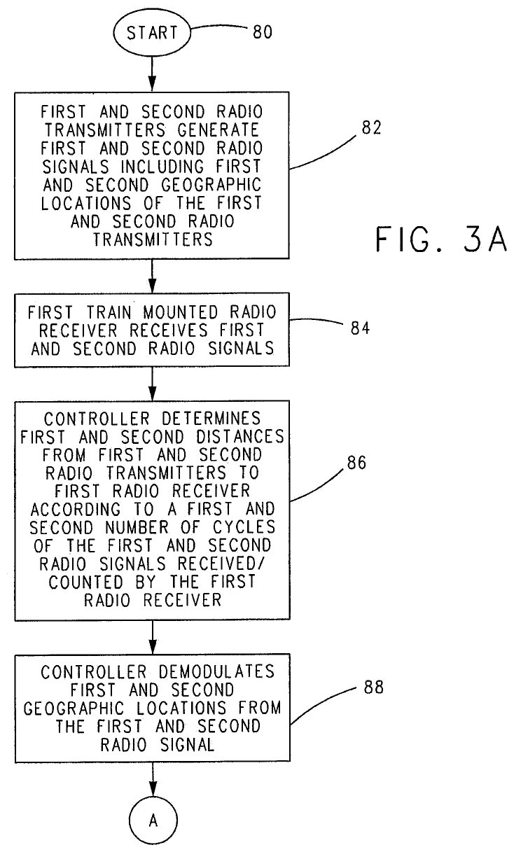

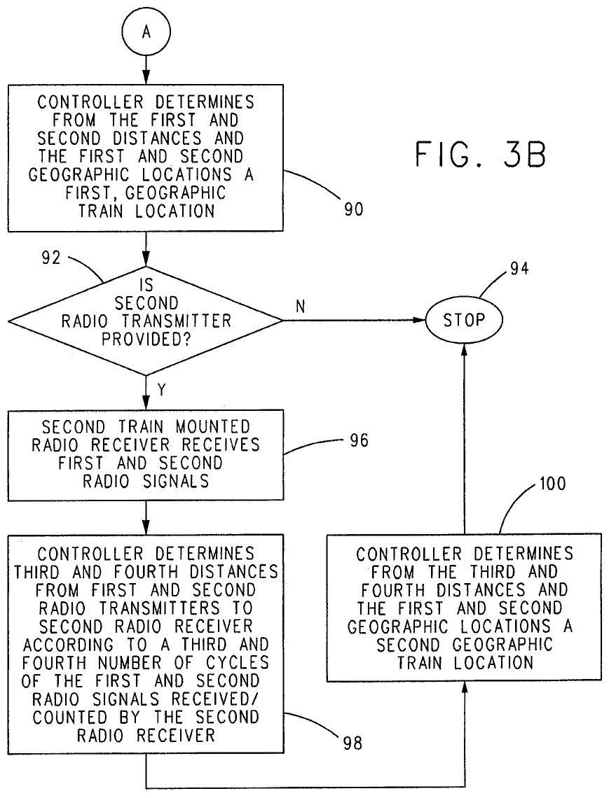

With reference to FIGS. 3A and 3B and continuing reference to FIG. 1, in one preferred and non-limiting embodiment or example, a method of determining a geographical location of a train 2 (locomotive 4) advances from a start step 80 to step 82 where first and second radio transmitters 6 and 18 generate first and second radio signals 10 and 30 having modulated thereon first and second geographical locations 8 and 26 of the first and second radio transmitters 6 and 18 modulated thereon. In step 84, a first train mounted radio receiver 12 receives the first and second radio signals 10 and 30. In step 86, a controller 20 determines first and second distances 22 and 44 from the first and second radio transmitters 6 and 18 to the first radio receiver 12 according to a number of cycles of the first and second radio signals 10 and 30 received/counted by the first radio receiver 12.

In step 88, controller 20 demodulates the first and second geographical locations 8 and 26 from the first and second radio signals 10 and 30. In step 90, controller 20 determines from the first and second distances 22 and 44 (determined in step 86) and the first and second geographical locations 8 and 26 demodulated from the first and second radio signals 10 and 30 (determined in step 88) a first geographical location 28 of train 2.

If, in step 92, it is determined that second radio receiver 14 is not provided, the method advances to stop step 94. If, however, second radio receiver 14 is provided, the method advances to step 96 where the second radio receiver 14 receives the first and second radio signals 10 and 30 from the first and second radio transmitters 6 and 18. In step 98, controller 20 determines third and fourth distances 46 and 34 from the first and second radio transmitters 6 and 18 to the second radio receiver 14 according to a third and fourth number of cycles of the first and second radio signals 10 and 30 received/counted by second radio receiver 14. In step 100, controller 20 determines from the third and fourth distances 46 and 34 (determined in step 98) and the first and second geographical locations 8 and 26 (demodulated in step 98) a second geographical location 36 of train 2. The method then advances to stop step 94.

The actual geographical location of the train can be the first geographical location, the second geographical location, or the combination (e.g., average) of the first and second geographical locations.

Each geographical location of the train can be determined via a triangulation distance measurement technique.

As can be seen, disclosed herein is a system and method for identifying the position of a train, e.g., a locomotive, when GPS satellite signals are not available. Triangulation between two radio transmitters and a single train mounted radio receiver, or between a single radio transmitter and two train mounted radio receivers, or between two radio transmitters and two train mounted radio receivers can be utilized to determine the geographical location of the train.

Although the invention has been described in detail for the purpose of illustration based on what is currently considered to be the most practical preferred and non-limiting embodiments, examples, or aspects, it is to be understood that such detail is solely for that purpose and that the invention is not limited to the disclosed preferred and non-limiting embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

The invention claimed is:

1. A method of determining a geographical location of a train comprising:
(a) generating, by first and second radio transmitters located at first and second geographical locations, first and second radio signals having modulated thereon the respective first and second geographical locations;
(b) receiving, by a first radio receiver mounted on the train, the first and second radio signals;
(c) determining, by a controller mounted on the train, according to a first and a second number of cycles of the respective first and second radio signals received/counted by the first radio receiver, a first distance from the first radio receiver to the first radio transmitter and a second distance from the first radio receiver to the second radio transmitter;
(d) demodulating, by the controller, from the first and second radio signals the first and second geographical locations; and
(e) determining, by the controller, from the first and second distances of step (c) and the first and second geographical locations of step (d) a first geographical location of the train.

2. The method of claim 1, further including:
(f) receiving, by a second radio receiver mounted on the train, the first and second radio signals;
(g) determining, by the controller, according to a third and a fourth number of cycles of the respective first and second radio signals received/counted by the second radio receiver, a third distance from the second radio receiver to the first radio transmitter and a fourth distance from the second radio receiver to the second radio transmitter;
(h) determining, by the controller, from the third and fourth distances of step (g) and the first and second geographical locations of step (d) a second geographical location of the train.

3. The method of claim 2, wherein the first and second geographical locations of the train are the same.

4. The method of claim 2, wherein the geographical location of a train is a combination (average) of the first and second geographical locations.

5. The method of claim 1, wherein the controller determines the first geographical location of the train via triangulation.

6. The method of claim 2, wherein the controller determines the first and second geographical locations of the train via triangulation.

7. The method of claim 1, wherein the first and second radio transmitters are located in a tunnel.

8. The method of claim 1, wherein the first radio receiver is mounted on a lead vehicle or a trailing vehicle of the train.

9. The method of claim 1, wherein the first and second radio signals are transmitted at different times.

10. A method of determining a geographical location of a train comprising:
(a) generating, by a first radio transmitter located at first geographical location, a first radio signal having modulated thereon the first geographical location of the first radio transmitter;
(b) receiving, by first and second radio receivers mounted on the train, the first radio signal;
(c) determining, by a controller mounted on the train, according to a first and a second number of cycles of the first radio signal received/counted by the respective first and second radio receivers, a first distance from the first radio receiver to the first radio transmitter and a second distance from the second radio receiver to the first radio transmitter;
(d) demodulating, by the controller, from the first radio signal the first geographical location of the first radio transmitter; and
(e) determining, by the controller, from the first and second distances of step (c) and the first geographical location of step (d) a first geographical location of the train.

11. The method of claim 10, further including:
(f) generating, by a second radio transmitter located at second geographical location, a second radio signal having modulated thereon the second geographical location of the second radio transmitter;
(g) receiving, by the first and second radio receivers, the second radio signal;
(h) determining, by the controller, according to a third and a fourth number of cycles of the second radio signal received/counted by the respective first and second radio receivers, a third distance from the first radio receiver to the second radio transmitter and a fourth distance from the second radio receiver to the second radio transmitter;
(i) demodulating, by the controller, from the second radio signal the second geographical location of the second radio transmitter; and
(j) determining, by the controller, from the third and fourth distances of step (h) and the second geographical location of step (i) a second geographical location of the train.

12. The method of claim 11, wherein the first and second geographical locations of the train are the same.

13. The method of claim 11, wherein the geographical location of a train is a combination (average) of the first and second geographical locations.

14. The method of claim 10, wherein the controller determines the first geographical location of the train via triangulation.

15. The method of claim 11, wherein the controller determines the first and second geographical locations of the train via triangulation.

16. The method of claim 11, wherein the first and second radio transmitters are located in a tunnel.

17. The method of claim 10, wherein the first and second radio receivers are mounted on a lead vehicle (e.g., locomotive) or a trailing vehicle of the train.

18. The method of claim 11, wherein the first and second radio signals are transmitted at different times.

19. The method of claim 10, wherein the first geographical location of the train in step (e) is further determined based on a geographical location of the train determined by the controller prior to step (e).

20. The method of claim 19, wherein the geographical location of the train determined by the controller prior to step (e) is determined from (1) satellite (e.g., GPS) data, (2) a gyroscope (e.g., a MEMS-based gyroscope), or (3) a heading of the train relative to a magnetic field of the earth (e.g., determined via a compass or a magnetometer).
